(19) United States
(12) Patent Application Publication
(10) Pub. No.: US 2024/0370701 A1
(43) Pub. Date: Nov. 7, 2024

(54) SPLIT KEY AND VALUE SELF-ATTENTION MACHINE LEARNING

(71) Applicant: Samsung Electronics Co., Ltd., Suwon-si (KR)

(72) Inventors: Suhel Jaber, San Jose, CA (US); Julia Isabel White, Palo Alto, CA (US)

(21) Appl. No.: 18/582,349

(22) Filed: Feb. 20, 2024

Related U.S. Application Data
(60) Provisional application No. 63/463,393, filed on May 2, 2023.

(51) Int. Cl. G06N 3/0455

(52) U.S. Cl. CPC G06N 3/0455

(57) ABSTRACT

A method includes receiving an input by a self-attention machine learning model and generating a set of queries using the input. This method also includes generating at least one of two sets of keys using the input and two sets of values using the input. This method also includes determining an output of the self-attention machine learning model using the two sets of keys, the two sets of values, or both. Another method includes identifying a query position for the set of queries, identifying a key position for the two sets of keys, and when the query position is determined to be equal to the key position, calculating an attention score using a first set of the two sets of keys, or, when the query position is determined to be unequal to the key position, calculating the attention score using a second set of the two sets of keys.

### CROSS-REFERENCE TO RELATED APPLICATION AND PRIORITY CLAIM

This application claims priority under 35 U.S.C. § 119 (e) to U.S. Provisional Patent Application No. 63/463,393 filed on May 2, 2023, which is hereby incorporated by reference in its entirety.

### TECHNICAL FIELD

This disclosure relates generally to machine learning systems and processes. More specifically, this disclosure relates to split key and value self-attention machine learning.

### BACKGROUND

Attention mechanisms in machine learning models have revolutionized the field of natural language processing (NLP), prompting breakthroughs across numerous language-based tasks. Self-attention mechanisms function by selectively enhancing and diminishing components of an embedded input sequence with the goal of devoting more focus toward important parts of the data. Attention can be interpreted as a vector of importance weights. That is, in order to predict or infer one element, such as a word in a sentence, estimations are made using the attention vector regarding how strongly the word is correlated with other elements of that sentence. A sum of values, weighted by the attention vector, are taken as an approximation of the target.

### SUMMARY

This disclosure relates to split key and value self-attention machine learning.

In a first embodiment, a method includes receiving an input by a self-attention machine learning model. The method also includes generating a set of queries using the input. The method further includes generating at least one of (i) two sets of keys using the input and (ii) two sets of values using the input. In addition, the method includes determining an output of the self-attention machine learning model using the two sets of keys, the two sets of values, or both.

In a second embodiment, an electronic device includes at least one processing device configured to receive an input by a self-attention machine learning model. The at least one processing device is also configured to generate a set of queries using the input. The at least one processing device is further configured to generate at least one of (i) two sets of keys using the input and (ii) two sets of values using the input. In addition, the at least one processing device is configured to determine an output of the self-attention machine learning model using the two sets of keys, the two sets of values, or both.

In a third embodiment, a non-transitory machine readable medium contains instructions that when executed cause at least one processor of an electronic device to receive an input by a self-attention machine learning model. The non-transitory machine-readable medium also contains instructions that when executed cause the at least one processor to generate a set of queries using the input. The non-transitory machine-readable medium further contains instructions that when executed cause the at least one processor to generate at least one of (i) two sets of keys using the input and (ii) two sets of values using the input. In addition, the non-transitory machine-readable medium contains instructions that when executed cause the at least one processor to determine an output of the self-attention machine learning model using the two sets of keys, the two sets of values, or both.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example language model architecture in accordance with this disclosure;

FIG. 3 illustrates an example process of a self-attention model in accordance with this disclosure;

FIG. 4 illustrates an example process for a split self-attention model in accordance with this disclosure;

FIG. 5 illustrates an example split-key self-attention method in accordance with this disclosure;

FIG. 6 illustrates an example split-value self-attention method in accordance with this disclosure; and

FIGS. 7A and 7B illustrate an example split-key and split-value self-attention method in accordance with this disclosure.

### DETAILED DESCRIPTION

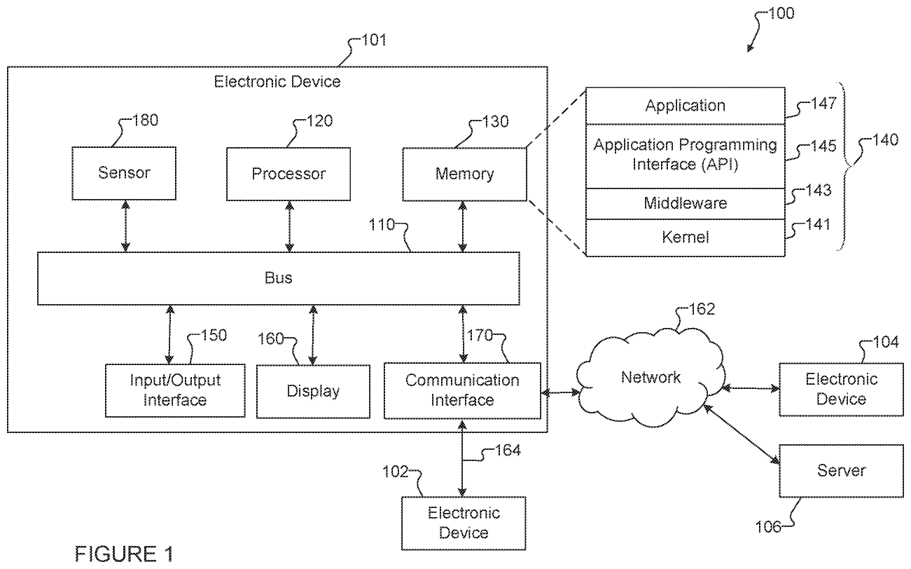

FIGS. 1 through 7B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, attention mechanisms in machine learning models have revolutionized the field of natural language processing (NLP), prompting breakthroughs across numerous language-based tasks. Self-attention mechanisms function by selectively enhancing and diminishing components of an embedded input sequence with the goal of devoting more focus toward important parts of the data. Attention can be interpreted as a vector of importance weights. That is, in order to predict or infer one element, such as a word in a sentence, estimations are made using the attention vector regarding how strongly the word is correlated with other elements of that sentence. A sum of values, weighted by the attention vector, are taken as an approximation of the target.

Existing self-attention mechanisms fail to leverage important aspects of elements used in reaching an attention output. Particularly, theoretical and empirical findings have discovered an importance of diagonal elements in a self-attention matrix. That is, the attention of an element with respect to itself tends to be significantly higher than the attention with respect to other components of the sequence. Traditional self-attention uses the same parameter matrix to compute on- and off-diagonal attention scores despite evidence of drastically different relationships between these components. Forcing one matrix to fit two very distinct relationships can result in problems with respect to training stability and task optimization. This disclosure thus provides split self-attention mechanisms that leverage these distinct trends by imposing separate learnable parameters for on- and off-diagonal attention components. Various embodiments of this disclosure include using split-key weights, diagonally-combined weights, and/or split-weight initialization.

In various embodiments, the self-attention model of this disclosure utilizes a split-key approach in which two sets of keys are created and initialized, where (i) the first set of keys is used when a query position is determined to be equal to the key position of the query and key matrices and (ii) the second set of keys is used when the query position is determined to be unequal to the key position. As result, the first set of keys may be used for on-diagonal components of the self-attention matrix, and the second set of keys may be used for off-diagonal components of the self-attention matrix. Also, in various embodiments, the self-attention model of this disclosure utilizes a split-value approach in which two sets of values are created and initialized, where (i) the first set of values is used when the query position is determined to be equal to the value position of the query and value matrices and (ii) the second set of values is used when the query position is determined to be unequal to the value position. As a result, the first set of values may be used for on-diagonal components of the self-attention matrix, and the second set of values may be used for off-diagonal components of the self-attention matrix. In various embodiments, both the split-key and split-value approaches can be used for the self-attention machine learning model.

Among other things, the split self-attention models of this disclosure can reduce training costs with faster convergence times. Furthermore, the proposed alteration can improve language model performance across a variety of natural language processing tasks, including but not limited to machine translation, text summarization, information retrieval, question answering, text classification, named entity recognition, parts of speech extraction, and slot filling.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to self-attention machine learning operations. For example, as described below, the processor 120 may receive and process inputs (such as audio inputs or data received from an audio input device like a microphone) and perform various tasks (such as natural language processing tasks using the inputs). The processor 120 may also instruct other devices to perform certain operations (such as outputting audio using an audio output device like a speaker) or display content on one or more displays 160. The processor 120 may further receive an input by a self-attention machine learning model, generate a set of queries using the input, generate at least one of two sets of keys using the input and two sets of values using the input, and determine an output of the self-attention machine learning model using the two sets of keys, the two sets of values, or both. In addition, the processor 120 may receive inputs (such as data samples to be used in training machine learning models) and manage such training by inputting the samples to the machine learning models, receive outputs from the machine learning models, and execute learning functions (such as one or more loss functions) to improve the machine learning models.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to self-attention machine learning operations. For example, the application 147 can include one or more applications supporting the receipt of an input by a self-attention machine learning model, generating a set of queries using the input, generating at least one of two sets of keys using the input and two sets of values using the input, and determining an output of the self-attention machine learning model using the two sets of keys, the two sets of values, or both. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to self-attention machine learning operations. For example, as described below, the server 106 may receive and process inputs (such as audio inputs or data received from an audio input device like a microphone) and perform various tasks (such as natural language processing tasks using the inputs). The server 106 may also instruct other devices to perform certain operations (such as outputting audio using an audio output device like a speaker) or display content on one or more displays 160. The server 106 may further receive an input by a self-attention machine learning model, generate a set of queries using the input, generate at least one of two sets of keys using the input and two sets of values using the input, and determine an output of the self-attention machine learning model using the two sets of keys, the two sets of values, or both. In addition, the server 106 may receive inputs (such as data samples to be used in training machine learning models) and manage such training by inputting the samples to the machine learning models, receive outputs from the machine learning models, and execute learning functions (such as loss functions) to improve the machine learning models.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

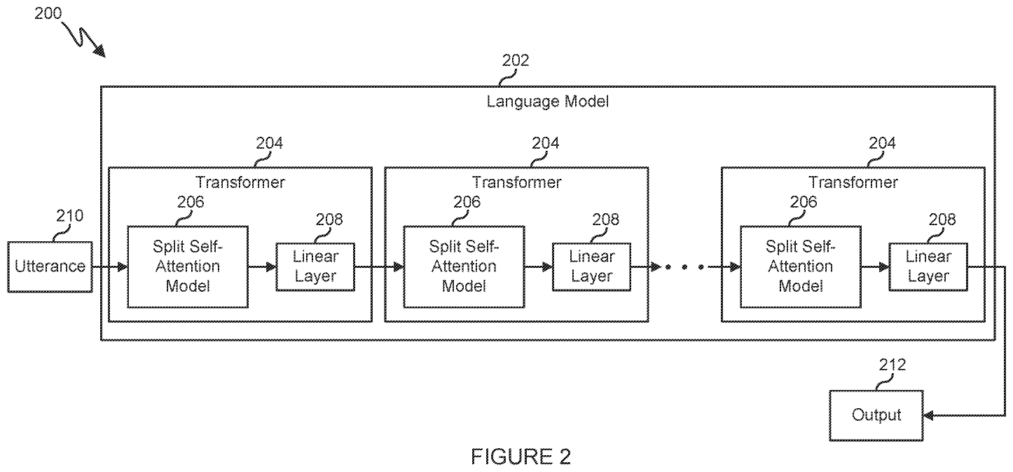

FIG. 2 illustrates an example language model architecture 200 in accordance with this disclosure. For case of explanation, the architecture 200 shown in FIG. 2 is described as being implemented on or supported by the electronic device 101 in the network configuration 100 of FIG. 1. However, the architecture 200 shown in FIG. 2 could be used with any other suitable device(s) and in any other suitable system(s), such as when the architecture 200 is implemented on or supported by the server 106.

As shown in FIG. 2, the language model architecture 200 includes a language model 202 having a plurality of transformers 204. Each of the transformers 204 include a split self-attention model 206 and a linear layer 208. In this example, when an utterance 210 is received by the language model 202, the utterance is processed by the split self-attention model 206 of the first transformer 204, and an attention result is processed through the linear layer 208. This can be repeated through each transformer 204 until a final output 212 is provided. The output 212 can be a goal, command, action, etc. For example, if the utterance 210 involves watching media content, the output 212 can be a goal or command to open or execute a specific media application on the electronic device 101. As described in this disclosure, the split self-attention model 206 can leverage the observed importance of on-diagonal components using, for example, a split-key approach, a split-value approach, or both a split-key and a split-value approach.

Although FIG. 2 illustrates one example of a language model architecture 200, various changes may be made to FIG. 2. For example, various components and functions in FIG. 2 may be combined, further subdivided, replicated, or rearranged according to particular needs. Also, one or more additional components and functions may be included if needed or desired. It will be understood, for instance, that details regarding the specific transformer layer architecture can be variable and subject to changes depending on the base large language model. Additionally, while FIG. 2 depicts how the split self-attention model 206 could be employed within the context of a goal extraction system using a language model, it will be understood that self-attention models, including the embodiments of the split self-attention model of this disclosure, can be used in performing any other appropriate tasks such as other sequencing tasks.

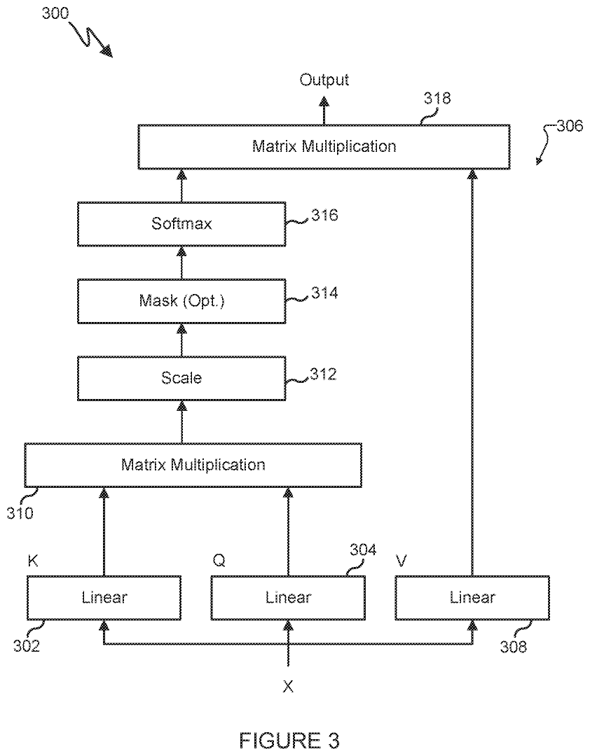

FIG. 3 illustrates an example process 300 of a self-attention model 306 in accordance with this disclosure. For case of explanation, the process 300 is described as involving the use of the electronic device 101 in the network configuration 100 of FIG. 1. However, the process 300 may be used with any other suitable electronic device (such as the server 106) or a combination of devices (such as the electronic device 101 and the server 106) and in any other suitable system(s).

As shown in FIG. 3, the process 300 includes receiving an input X by the self-attention model 306. The input X is provided to each of a key layer 302, a query layer 304, and a value layer 308. Self-attention mechanisms allow a model to focus attention on different components of an input while producing output through a system of query, key-value pair vectors. The output of the attention mechanism is computed as a weighted sum of values, where the weight assigned to each value is computed by a compatibility function of the query and corresponding key. Formally, a traditional self-attention model accepts an embedded input sequence X∈ [symbol] ^{L×d}^{_{model}} of length L. A set of queries Q=[q₁, q₂, . . . q_{L}], keys K=[k₁, k₂, . . . , k_{L}], and values V=[v₁, v₂, . . . , v_{L}] corresponding to each of the L positions in the sequence are obtained as projections of the input via parameter matrices W^{Q}, W^{K}, W^{V}, respectively. The creation of the set of queries, keys, and values may be expressed as follows.

$$Q = X {W}^{Q} , {W}^{Q} ∈ {ℝ}^{{d}_{model} \times d}$$

$$K = X {W}^{K} , {W}^{K} ∈ {ℝ}^{{d}_{model} \times d}$$

$$V = X {W}^{V} , {W}^{V} ∈ {ℝ}^{{d}_{model} \times d}$$

At each position i, the corresponding query vector qᵢ∈ [symbol] ^{d} is matched against the full set of keys to produce an attention score. This matching operation is computed, at a matrix multiplication operation 310, as the dot product of the query under consideration with the key vector kⱼ∈ [symbol] ^{d} at each position j. The scores may be expressed as follows.

$${score}_{ij} = {q}_{i} \cdot {k}_{j}$$

The attention score scoreᵢⱼ for each query can be scaled at a scaling operation 312 and optionally masked at a masking operation 314. The combined scores score∈ [symbol] ^{L×L} are passed through a softmax operation 316 to normalize the scores and generate an attention probability distribution. The attention result is computed, such as at another matrix multiplication operation 318, by a weighted sum of the value vectors where each value vector is paired with a corresponding key. The attention results may be expressed as follows.

$$Attention ( Q , K , V ) = softmax ( \frac{scor e}{\sqrt{d}} ) V$$

Here, d is a value corresponding to the dimension of the key vectors.

Although FIG. 3 illustrates one example process 300 of a self-attention model 306, various changes may be made to FIG. 3. For example, various components and functions in FIG. 3 may be combined, further subdivided, replicated, or rearranged according to particular needs. Also, one or more additional components and functions may be included if needed or desired. Additionally, while shown as a series of steps, various steps in FIG. 3 could overlap, occur in parallel, occur in a different order, or occur any number of times (including zero times).

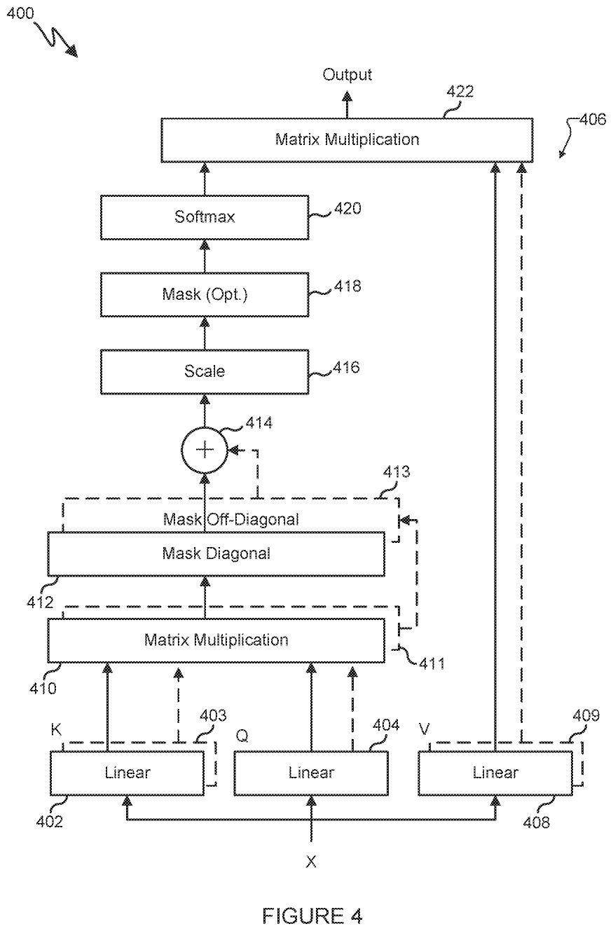

FIG. 4 illustrates an example process 400 for a split self-attention model 406 in accordance with this disclosure. For case of explanation, the process 400 is described as involving the use of the electronic device 101 in the network configuration 100 of FIG. 1. However, the process 400 may be used with any other suitable electronic device (such as the server 106) or a combination of devices (such as the electronic device 101 and the server 106) and in any other suitable system(s). It will be understood that the split self-attention model 406 can be the split self-attention model 206 shown in FIG. 2.

As shown in FIG. 4, the process 400 includes receiving an input X by the split self-attention model 406. Traditional self-attention, such as is described with respect to FIG. 3, uses the same parameter matrix to compute attention scores between a token and itself (on-diagonal) and between a token and other tokens (off-diagonal) despite evidence of drastically different relationships between these components. Forcing one matrix to fit two very distinct relationships can result in problems with respect to training stability and task optimization. Intuitively, what traditional self-attention does is figure out, for each token in the sentence (referred to herein as the “current token”), how to form a contextualized representation that includes a portion of the current token itself plus portions of the tokens around it based on a notion of their relevance to the current token. Traditional self-attention mechanism perform this by calculating how similar a linear transformation Q (query) of the current token is to a linear transformation K (key) of each token in the sentence (including the current token itself), normalizing these similarity scores into a sequence of weights that add up to one, and taking the sum of weighted linear transformations V of each token in the sentence (where the weight applied to each token is the relevant one calculated in the previous point).

One potential problem with this approach is that the linear transformations K and V are not performed differently for the current token versus the other tokens. That is, the linear transformations are all performed independently and before the comparison. More specifically, when the linear transformation K of a token is calculated, no care is taken to calculate it differently based on whether it will be compared to the Q of the same token or a different one. In general, K is used to determine the measure in which the V of the same token will contribute to the final representation of the current token. As a result, if K of the current token is not produced in a specialized fashion, it follows that no specialized estimate can be performed of how much the initial non-contextualized representation V of the current token should contribute to the final contextualized representation of itself.

Moreover, when the linear transformation V of a token is calculated, no care is taken to calculate it differently based on whether it will enter the final representation of the current token. From a linguistic point of view, it is known that the head of the phrase should be considered specially in forming the semantic composition of a phrase. For example, for a verb phrase, the verb (which is the head) is what determines the overall semantic frame for the phrase. As one example, one form of the verb “give” takes as mandatory arguments a noun phrase indicating the given thing and a prepositional phrase indicating its recipient (“give toys to children”). In other words, the semantic content of the head takes priority in a phrase and determines the overall structure of the semantic frame (such as its representation) for the phrase where the other arguments will be included. A transformer forms representations of phrases of which a current token is the head. For that reason, embodiments of this disclosure provide a split self-attention approach in which calculations of K and/or V for the current token are specialized in order to give priority to the semantic content of the current token and to form the proper foundational representation to which semantic content of other tokens in the phrase will be added.

Thus, to leverage and emphasize the on-diagonal components of self-attention matrices, the split self-attention model 406 can use a split-key approach, a split-value approach, or both a split-key approach and a split-value approach. For example, as shown in FIG. 4, the process 400 in some embodiments can include a first key layer 402 and a second key layer 403 in the split self-attention model 406 such that two sets of keys are created from the input X. As another example, as shown in FIG. 4, the process 400 in some embodiments can include a first value layer 408 and a second value layer 409 in the split self-attention model 406 such that two sets of values are created from the input X. In particular embodiments, the split self-attention model 406 can use the two sets of keys, such as a split-key approach. In other particular embodiments, the split self-attention model 406 can use the two sets of values, such as a split-value approach. In still other particular embodiments, the split self-attention model 406 can use both the two sets of keys and the two sets of values, such as a split-key and split-value approach.

When using split-key self-attention where two sets of keys are created at the first and second key layers 302-303, the separate keys are used to compute attention scores when the score corresponds to the same query and key position. In other words, the attention score scoreᵢⱼ uses separate keys when query position i is equal to key position j (such as the diagonal components of score). The scores may be expressed as follows.

$${score}_{ij} = {q}_{i} \cdot {k}_{diag , j} i == j$$

$${score}_{ij} = {q}_{i} \cdot {k}_{off , j} i != j$$

In this example, the two sets of keys are calculated at the first and second key layers 302-303 with distinct parameter matrices, such as the following parameter matrices.

$$K 1 = X {W}^{{K}_{diag}} , {W}^{{K}_{diag}} ∈ {ℝ}^{{d}_{model} \times d}$$

$$K 2 = X {W}^{{K}_{off}} , {W}^{{K}_{off}} ∈ {ℝ}^{{d}_{model} \times d}$$

A specialized initialization procedure can be used for the two sets of keys that is inspired by observed trends in attention scores where higher attention tends to be consistently attributed to on-diagonal components. For example, the model can be initialized so that attention scores of off-diagonal components are minimized with respect to on-diagonal components. In some embodiments, this may be accomplished by initializing the parameter matrices such that W^{K}^{_{diag}} is sampled from the uniform distribution U(−stdv+ε, stdv+ε) and W^{K}^{_{off}} is sampled from the distribution U(−stdv−ε,stdv−ε) for some non-negative epsilon ε.

Once the keys are created, the attention score scoreᵢⱼ is determined for each query under consideration by performing matrix multiplication of the query matrix under consideration with the corresponding key. For example, as shown in FIG. 4, a first matrix multiplication operation layer 410 can be used for the first set of keys k_{diag} when the query position equals the key position, and a second matrix multiplication operation layer 411 can be used for the second set of keys k_{off} when the query position does not equal the key position.

In some embodiments, the output scores from the first and second matrix multiplication layers 410-411 are masked at a first diagonal masking operation 412 and a second off-diagonal masking operation 413. The scores pertaining to a query can be combined at a summation operation 414. A scaling operation 416 can be performed, followed by an optional masking operation 418. The combined scores score∈ [symbol] ^{L×L} are passed through a softmax operation 420 to normalize the scores and generate an attention probability distribution. It will be understood that functions other than a softmax function could be used here to normalize the scores. The attention result is computed, such as at another matrix multiplication operation 422, by a weighted sum of the value vectors, where each value vector is paired with a corresponding key.

Additionally or alternatively, the process 400 can include using split-value self-attention where two sets of values are created using a first value layer 408 and a second value layer 409. In such embodiments, separate values are used when the query position query position i is equal to value position j. That is, when computing the attention result, such as at the matrix multiplication operation 422, the separate value sets are combined with the normalized attention scores depending on the corresponding query and value positions. The attention scores may be expressed as follows.

$$Attention {( Q , K , V )}_{i j} = {\sum }_{h = 1}^{L} softmax ( \frac{{score}_{i h}}{\sqrt{d}} ) {V}_{diag , hj} i == j$$

$${\sum }_{h = 1}^{L} softmax ( \frac{{score}_{i h}}{\sqrt{d}} ) {V}_{off , hj} i != j$$

Here, d is a value corresponding to the dimension of the key vectors. The two sets of values are calculated with distinct parameter matrices, such as the following parameter matrices.

$${V}_{diag} = X {W}^{{V}_{d i a g}} , {W}^{{V}_{d i a g}} ∈ {ℝ}^{{d}_{model} \times d}$$

$${V}_{off} = X {W}^{{V}_{off}} , {W}^{{V}_{off}} ∈ {ℝ}^{{d}_{model} \times d}$$

Embodiments of the process 400 can include using split-key self-attention, split-value self-attention, or both split-key and split-value self-attention. It will be understood that, when using split-key attention only, the second value layer 409 is not used. It will also be understood that, when using split-value attention only, the second key layer 403, the second matrix multiplication operation 411, the masking operations 412-413, and the summation operation 414 are not used. In addition, it will be understood that, when using both split-key and split-value attention, all the operations in the process 400 can be used.

Although FIG. 4 illustrates one example process 400 of a split self-attention model 406, various changes may be made to FIG. 4. For example, various components and functions in FIG. 4 may be combined, further subdivided, replicated, or rearranged according to particular needs. Also, one or more additional components and functions may be included if needed or desired. Additionally, while shown as a series of steps, various steps in FIG. 4 could overlap, occur in parallel, occur in a different order, or occur any number of times (including zero times).

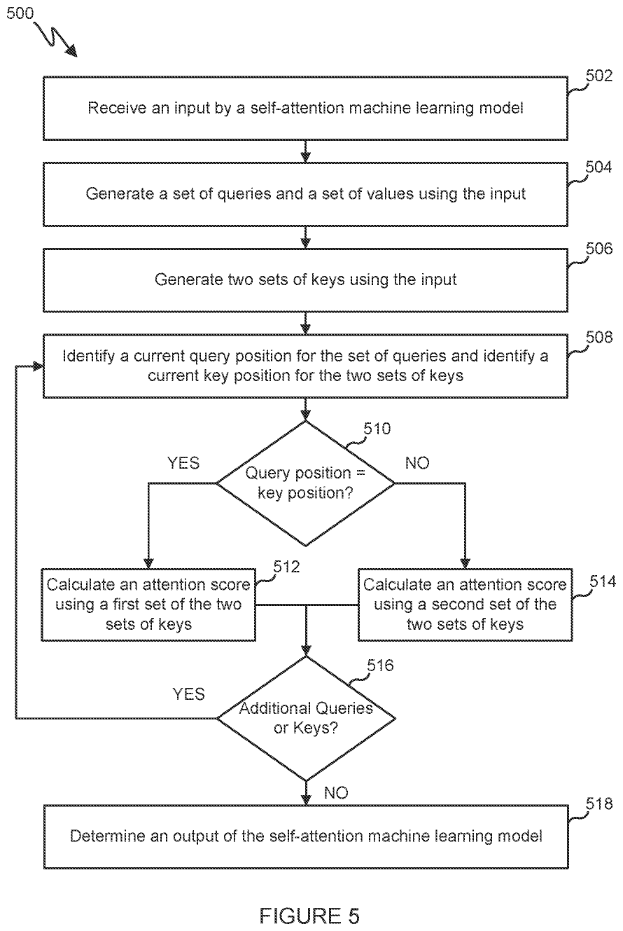

FIG. 5 illustrates an example split-key self-attention method 500 in accordance with this disclosure. For ease of explanation, the method 500 is described as involving the use of the electronic device 101 in the network configuration 100 of FIG. 1. However, the method 500 may be used with any other suitable electronic device (such as the server 106) or a combination of devices (such as the electronic device 101 and the server 106) and in any other suitable system(s).

As shown in FIG. 5, at step 502, an input is received by a self-attention machine learning model, such as the self-attention model 206 or 406. This may include, for example, the processor 120 of the electronic device 101 obtaining the input from any suitable source, such as an audio input or utterance received via an audio input device or microphone. In various embodiments, the self-attention machine learning model can form a part of a large language machine learning model. At step 504, a set of queries and a set of values are generated using the input. This may include, for example, the processor 120 of the electronic device 101 executing the query layer 404 and the value layer 408 as shown and described with respect to FIG. 4.

As described in this disclosure, an output of the self-attention machine learning model can be determined using two sets of keys, two sets of values, or both. In the example of FIG. 5, the self-attention model is configured to use two sets of keys. At step 506, the two sets of keys are generated using the input. This may include, for example, the processor 120 of the electronic device 101 executing the first and second key layers 402-403 as shown and described with respect to FIG. 4. In some embodiments, to generate the two sets of keys, the input is combined with two different parameter matrices, each one of the two parameter matrices corresponding to one of the two sets of keys. The two parameter matrices may be initialized to minimize off-diagonal components of the attention score with respect to on-diagonal components of the attention score.

At step 508, a current query position is identified for the set of queries and a current key position is identified for the two sets of keys. At step 510, it is determined whether the query position equals the key position. For example, during a self-attention process, each query in a set of queries is combined via matrix multiplication with each key of a set of keys. In this case, however, separate key sets are used depending on whether the query position i is equal to key position j, such as the diagonal components of the score. When the query position is determined to be equal to the key position, at step 512, an attention score is calculated using a first set of the two sets of keys. When the query position is determined to be unequal to the key position, at step 514, an attention score is calculated using a second set of the two sets of keys. This may include, for example, the processor 120 of the electronic device 101 executing the matrix multiplication operations 410-411 to combine the current query with the current key.

At step 516, it is determined whether additional keys or queries are to be processed. For example, each query corresponding to the current query position can be combined with each key of each key position (using the one of the two sets of keys as appropriate) via matrix multiplication. Also, once that query has been combined with each key, a next query in the set of queries can be processed and combined with each appropriate key from the set of keys depending on the query and key positions. After each query is processed, at step 518, an output of the self-attention model is determined. For example, this can include performing the masking operations 412-413, the summation operation 414, the scaling operation 416, the optional masking operation 418, the softmax operation 420, and the matrix multiplication operation 422 as shown and described with respect to FIG. 4.

Although FIG. 5 illustrates one example of a split-key self-attention method 500, various changes may be made to FIG. 5. For example, while shown as a series of steps, various steps in FIG. 5 could overlap, occur in parallel, occur in a different order, or occur any number of times (including zero times).

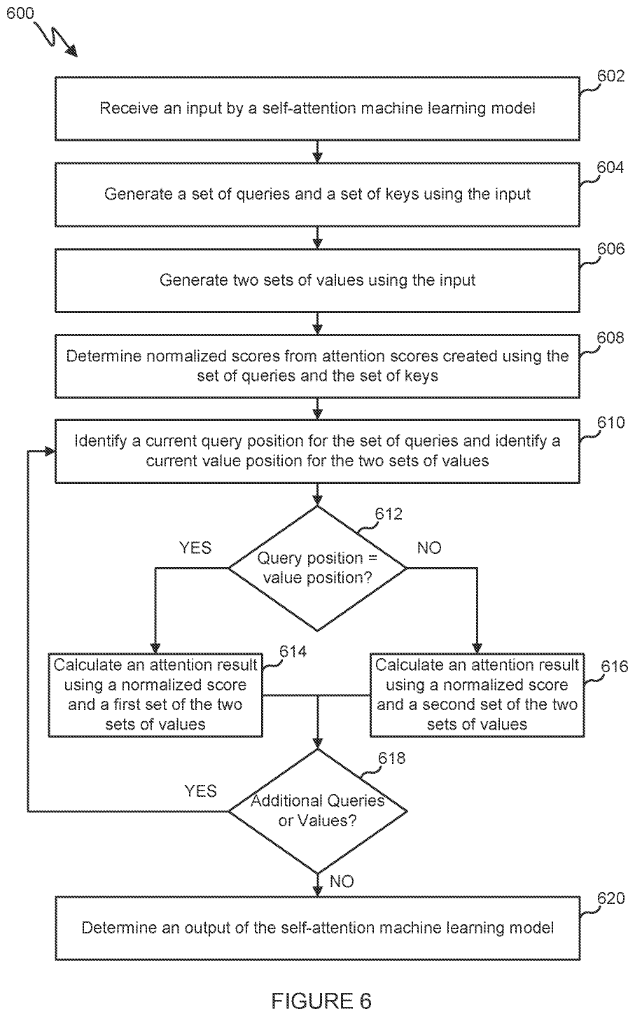

FIG. 6 illustrates an example split-value self-attention method 600 in accordance with this disclosure. For ease of explanation, the method 600 is described as involving the use of the electronic device 101 in the network configuration 100 of FIG. 1. However, the method 600 may be used with any other suitable electronic device (such as the server 106) or a combination of devices (such as the electronic device 101 and the server 106) and in any other suitable system(s).

As shown in FIG. 6, at step 602, an input is received by a self-attention machine learning model, such as the self-attention model 206 or 406. This may include, for example, the processor 120 of the electronic device 101 obtaining the input from any suitable source, such as an audio input or utterance received via an audio input device or microphone. In various embodiments, the self-attention machine learning model can form a part of a large language machine learning model. At step 604, a set of queries and a set of keys are generated using the input. This may include, for example, the processor 120 of the electronic device 101 executing the key layer 402 and the query layer 404 as shown and described with respect to FIG. 4.

As described in this disclosure, an output of the self-attention machine learning model can be determined using two sets of keys, two sets of values, or both. In the example of FIG. 6, the self-attention model is configured to use two sets of values. At step 606, the two sets of values are generated using the input. This may include, for example, the processor 120 of the electronic device 101 executing the first and second value layers 408-409 as shown and described with respect to FIG. 4. In some embodiments, to generate the two sets of values, the input is combined with two parameter matrices, each one of the two parameter matrices corresponding to one of the two sets of values.

At step 608, normalized scores are determined from attention scores created using the set of queries and the set of keys. This may include, for example, the processor 120 of the electronic device 101 executing the matrix multiplication operation 410 to combine the queries and keys, the scaling operation 416, the optional masking operation 418, and the softmax operation 420 in order to create the normalized scores as shown and described with respect to FIG. 4.

At step 610, a current query position is identified for the set of queries and a current value position is identified for the two sets of values. At step 612, it is determined whether the query position equals the value position. For example, during the self-attention process, each normalized score for a query in a set of queries is combined via matrix multiplication with each value of a set of values. In this case, however, separate value sets are used depending on whether the query position i is equal to value position j. When the query position is determined to be equal to the value position, at step 614, an attention result is calculated using the normalized score and a first set of the two sets of values. When the query position is determined to be unequal to the value position, at step 616, an attention result is calculated using the normalized score and a second set of the two sets of values. This may include, for example, the processor 120 of the electronic device 101 executing the matrix multiplication operation 422 to combine the normalized score for the current query with the current value.

At step 618, it is determined whether additional queries or values are to be processed. For example, each normalized score for a query corresponding to the current query position can be combined with each value of each value position (using the one of the two sets of values as appropriate) via matrix multiplication. Also, once the normalized scores for that query have been combined with the values, normalized scores for a next query in the set of queries can be processed and combined with each appropriate value from the set of values depending on the query and value positions. After the normalized scores are processed, at step 620, an output of the self-attention model is determined. In some embodiments, this can include performing a summing operation using all the attention results calculated by the method 600.

Although FIG. 6 illustrates one example of a split-value self-attention method 600, various changes may be made to FIG. 6. For example, while shown as a series of steps, various steps in FIG. 6 could overlap, occur in parallel, occur in a different order, or occur any number of times (including zero times).

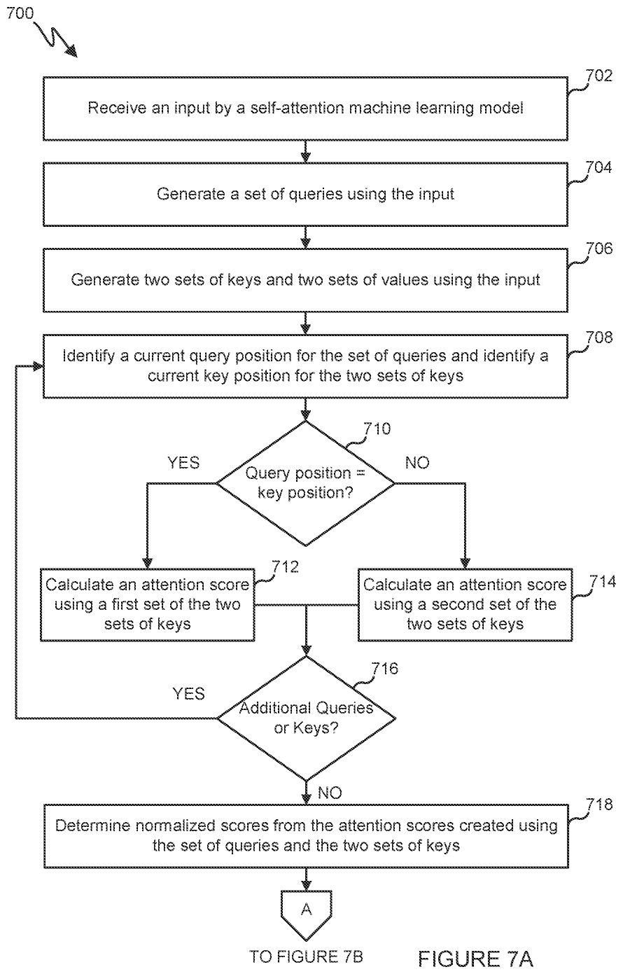

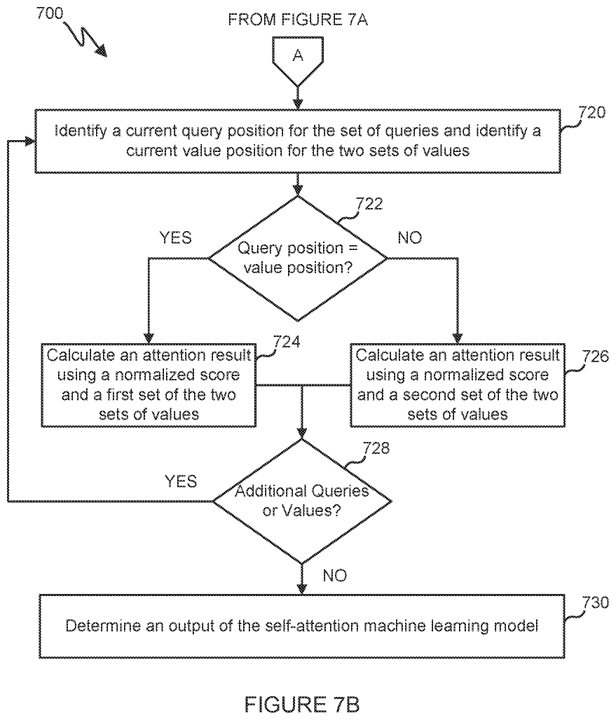

FIGS. 7A and 7B illustrate an example split-key and split-value self-attention method 700 in accordance with this disclosure. For case of explanation, the method 700 is described as involving the use of the electronic device 101 in the network configuration 100 of FIG. 1. However, the method 700 may be used with any other suitable electronic device (such as the server 106) or a combination of devices (such as the electronic device 101 and the server 106) and in any other suitable system(s).

At step 702, an input is received by a self-attention machine learning model, such as the self-attention model 206 or 406. This may include, for example, the processor 120 of the electronic device 101 obtaining the input from any suitable source, such as an audio input or utterance received via an audio input device or microphone. In various embodiments, the self-attention machine learning model can form a part of a large language machine learning model. At step 704, a set of queries is generated using the input. This may include, for example, the processor 120 of the electronic device 101 executing the query layer 404 as shown and described with respect to FIG. 4.

As described in this disclosure, an output of the self-attention machine learning model can be determined using two sets of keys, two sets of values, or both. In the example of FIGS. 7A and 7B, the self-attention model is configured to use both two sets of keys and two sets of values. At step 706, the two sets of keys and the two sets of values are generated using the input. This may include, for example, the processor 120 of the electronic device 101 executing the first and second key layers 402-403 as well as the first and second value layers 408-409 as shown and described with respect to FIG. 4. In some embodiments, to generate the two sets of keys, the input is combined with two different parameter matrices, each one of the two parameter matrices corresponding to one of the two sets of keys. The two parameter matrices may be initialized to minimize off-diagonal components of the attention score with respect to on-diagonal components of the attention score. In some embodiments, to generate the two sets of values, the input is combined with two parameter matrices, each one of the two parameter matrices corresponding to one of the two sets of values.

At step 708, a current query position is identified for the set of queries and a current key position is identified for the two sets of keys. At step 710, it is determined whether the query position equals the key position. For example, during a self-attention process, each query in a set of queries is combined via matrix multiplication with each key of a set of keys. In this case, however, separate key sets are used depending on whether the query position i is equal to key position j, such as the diagonal components of the score. When the query position is determined to be equal to the key position, at step 712, an attention score is calculated using a first set of the two sets of keys. When the query position is determined to be unequal to the key position, at step 714, an attention score is calculated using a second set of the two sets of keys. This may include, for example, the processor 120 of the electronic device 101 executing the matrix multiplication operations 410 and 411 to combine the current query with the current key.

At step 716, it is determined whether additional keys or queries are to be processed. For example, each query corresponding to the current query position can be combined with each key of each key position (using the one of the two sets of keys as appropriate) via matrix multiplication. Also, once that query has been combined with each key, a next query in the set of queries can be processed and combined with each appropriate key from the set of keys depending on the query and key positions. After each query is processed, at step 718, normalized scores are determined from the attention scores created using the set of queries and the two sets of keys. For example, this can include performing the masking operations 412-413, the summation operation 414, the scaling operation 416, the optional masking operation 418, and the softmax operation 420 as shown and described with respect to FIG. 4.

At step 720, a current query position is identified for the set of queries and a current value position is identified for the two sets of values. At step 722, it is determined whether the query position equals the value position. For example, during the self-attention process, each normalized score for a query in a set of queries is combined via matrix multiplication with each value of a set of values. In this case, however, separate value sets are used depending on whether the query position i is equal to value position j. When the query position is determined to be equal to the value position, at step 724, an attention result is calculated using the normalized score and a first set of the two sets of values. When the query position is determined to be unequal to the value position, at step 726, an attention result is calculated using the normalized score and a second set of the two sets of values. This may include, for example, the processor 120 of the electronic device 101 executing the matrix multiplication operation 422 to combine the normalized score for the current query with the current value.

At step 728, it is determined whether additional queries or values are to be processed. For example, each normalized score for a query corresponding to the current query position can be combined with each value of each value position (using the one of the two sets of values as appropriate) via matrix multiplication. Also, once the normalized scores for that query have been combined with the values, normalized scores for a next query in the set of queries can be processed and combined with each appropriate value from the set of values depending on the query and value positions. After the normalized scores are processed, at step 730, an output of the self-attention model is determined. In some embodiments, this can include performing a summing operation using all the attention results calculated by the method 700.

Although FIGS. 7A and 7B illustrate one example of a split-key and split-value self-attention method 700, various changes may be made to FIGS. 7A and 7B. For example, while shown as a series of steps, various steps in FIGS. 7A and 7B could overlap, occur in parallel, occur in a different order, or occur any number of times (including zero times).

It should be noted that the functions shown in FIGS. 2 through 7B or described above can be implemented in an electronic device 101, 102, 104, server 106, or other device(s) in any suitable manner. For example, in some embodiments, at least some of the functions shown in FIGS. 2 through 7B or described above can be implemented or supported using one or more software applications or other software instructions that are executed by the processor 120 of the electronic device 101, 102, 104, server 106, or other device(s). In other embodiments, at least some of the functions shown in FIGS. 2 through 7B or described above can be implemented or supported using dedicated hardware components. In general, the functions shown in FIGS. 2 through 7B or described above can be performed using any suitable hardware or any suitable combination of hardware and software/firmware instructions. Also, the functions shown in FIGS. 2 through 7B or described above can be performed by a single device or by multiple devices. For instance, the server 106 might be used to train the machine learning model 206, and the server 106 could deploy the trained machine learning model 206 to one or more other devices (such as the electronic device 101) for use.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving an input by a self-attention machine learning model;
generating a set of queries using the input;
generating at least one of (i) two sets of keys using the input and (ii) two sets of values using the input; and
determining an output of the self-attention machine learning model using the two sets of keys, the two sets of values, or both.

2. The method of claim 1, wherein determining the output of the self-attention machine learning model includes:
identifying a query position for the set of queries;
identifying a key position for the two sets of keys;
determining whether the query position equals the key position; and
calculating an attention score using a first set of the two sets of keys when the query position is determined to be equal to the key position or using a second set of the two sets of keys when the query position is determined to be unequal to the key position.

3. The method of claim 2, wherein:
generating the two sets of keys includes combining the input with two parameter matrices;
each one of the two parameter matrices corresponds to one of the two sets of keys; and
the two parameter matrices are initialized to minimize off-diagonal components of the attention score with respect to on-diagonal components of the attention score.

4. The method of claim 2, wherein determining the output of the self-attention machine learning model further includes:
creating a normalized score using the attention score;
identifying a value position for the two sets of values;
determining whether the query position equals the value position;
calculating an attention result using the normalized score and a first set of the two sets of values when the query position is determined to be equal to the value position or using the normalized score and a second set of the two sets of values when the query position is determined to be unequal to the value position; and
generating the output of the self-attention machine learning model using the attention result.

5. The method of claim 1, wherein determining the output of the self-attention machine learning model includes:
creating a normalized score using an attention score;
identifying a query position for the set of queries;
identifying a value position for the two sets of values;
determining whether the query position equals the value position;
calculating an attention result using the normalized score and a first set of the two sets of values when the query position is determined to be equal to the value position or using the normalized score and a second set of the two sets of values when the query position is determined to be unequal to the value position; and
generating the output of the self-attention machine learning model using the attention result.

6. The method of claim 5, wherein:
generating the two sets of values includes combining the input with two parameter matrices; and
each one of the two parameter matrices corresponds to one of the two sets of values.

7. The method of claim 1, wherein the self-attention machine learning model forms a part of a large language machine learning model.

8. An electronic device comprising:
at least one processing device configured to:
receive an input by a self-attention machine learning model;
generate a set of queries using the input;
generate at least one of (i) two sets of keys using the input and (ii) two sets of values using the input; and
determine an output of the self-attention machine learning model using the two sets of keys, the two sets of values, or both.

9. The electronic device of claim 8, wherein, to determine the output of the self-attention machine learning model, the at least one processing device is configured to:
identify a query position for the set of queries;
identify a key position for the two sets of keys;
determine whether the query position equals the key position; and
calculate an attention score using a first set of the two sets of keys when the query position is determined to be equal to the key position or using a second set of the two sets of keys when the query position is determined to be unequal to the key position.

10. The electronic device of claim 9, wherein:
to generate the two sets of keys, the at least one processing device is configured to combine the input with two parameter matrices;
each one of the two parameter matrices corresponds to one of the two sets of keys; and
the two parameter matrices are initialized to minimize off-diagonal components of the attention score with respect to on-diagonal components of the attention score.

11. The electronic device of claim 9, wherein, to determine the output of the self-attention machine learning model, the at least one processing device is configured to:
create a normalized score using the attention score;
identify a value position for the two sets of values;
determine whether the query position equals the value position;
calculate an attention result using the normalized score and a first set of the two sets of values when the query position is determined to be equal to the value position or using the normalized score and a second set of the two sets of values when the query position is determined to be unequal to the value position; and
generate the output of the self-attention machine learning model using the attention result.

12. The electronic device of claim 8, wherein, to determine the output of the self-attention machine learning model, the at least one processing device is configured to:
create a normalized score using an attention score;
identify a query position for the set of queries;
identify a value position for the two sets of values;
determine whether the query position equals the value position;
calculate an attention result using the normalized score and a first set of the two sets of values when the query position is determined to be equal to the value position or using the normalized score and a second set of the two sets of values when the query position is determined to be unequal to the value position; and
generate the output of the self-attention machine learning model using the attention result.

13. The electronic device of claim 12, wherein:
to generate the two sets of values, the at least one processing device is configured to combine the input with two parameter matrices; and
each one of the two parameter matrices corresponds to one of the two sets of values.

14. The electronic device of claim 8, wherein the self-attention machine learning model forms a part of a large language machine learning model.

15. A non-transitory machine readable medium containing instructions that when executed cause at least one processor of an electronic device to:
receive an input by a self-attention machine learning model;
generate a set of queries using the input;
generate at least one of (i) two sets of keys using the input and (ii) two sets of values using the input; and
determine an output of the self-attention machine learning model using the two sets of keys, the two sets of values, or both.

16. The non-transitory machine readable medium of claim 15, wherein the instructions that when executed cause the at least one processor to determine the output of the self-attention machine learning model include:
instructions that when executed cause the at least one processor to identify a query position for the set of queries;
instructions that when executed cause the at least one processor to identify a key position for the two sets of keys;
instructions that when executed cause the at least one processor to determine whether the query position equals the key position; and
instructions that when executed cause the at least one processor to calculate an attention score using a first set of the two sets of keys when the query position is determined to be equal to the key position or using a second set of the two sets of keys when the query position is determined to be unequal to the key position.

17. The non-transitory machine readable medium of claim 16, wherein:
the instructions that when executed cause the at least one processor to generate the two sets of keys include instructions that when executed cause the at least one processor to combine the input with two parameter matrices;
each one of the two parameter matrices corresponds to one of the two sets of keys; and
the two parameter matrices are initialized to minimize off-diagonal components of the attention score with respect to on-diagonal components of the attention score.

18. The non-transitory machine readable medium of claim 16, wherein the instructions that when executed cause the at least one processor to determine the output of the self-attention machine learning model include:
instructions that when executed cause the at least one processor to create a normalized score using the attention score;
instructions that when executed cause the at least one processor to identify a value position for the two sets of values;
instructions that when executed cause the at least one processor to determine whether the query position equals the value position;
instructions that when executed cause the at least one processor to calculate an attention result using the normalized score and a first set of the two sets of values when the query position is determined to be equal to the value position or using the normalized score and a second set of the two sets of values when the query position is determined to be unequal to the value position; and
instructions that when executed cause the at least one processor to generate the output of the self-attention machine learning model using the attention result.

19. The non-transitory machine readable medium of claim 15, wherein the instructions that when executed cause the at least one processor to determine the output of the self-attention machine learning model include:
instructions that when executed cause the at least one processor to create a normalized score using an attention score;
instructions that when executed cause the at least one processor to identify a query position for the set of queries;
instructions that when executed cause the at least one processor to identify a value position for the two sets of values;
instructions that when executed cause the at least one processor to determine whether the query position equals the value position;
instructions that when executed cause the at least one processor to calculate an attention result using the normalized score and a first set of the two sets of values when the query position is determined to be equal to the value position or using the normalized score and a second set of the two sets of values when the query position is determined to be unequal to the value position; and
instructions that when executed cause the at least one processor to generate the output of the self-attention machine learning model using the attention result.

20. The non-transitory machine readable medium of claim 19, wherein:
the instructions that when executed cause the at least one processor to generate the two sets of values include instructions that when executed cause the at least one processor to combine the input with two parameter matrices; and
each one of the two parameter matrices corresponds to one of the two sets of values.
